(19) United States
(12) Patent Application Publication
(10) Pub. No.: US 2013/0131230 A1
(43) Pub. Date: May 23, 2013

(54) Tackifiers For Composite Articles

(71) Applicants: Mohamed Bouguettaya, Farmington, MI (US); Nicholas Foley, Charlotte, NC (US)

(72) Inventors: Mohamed Bouguettaya, Farmington, MI (US); Nicholas Foley, Charlotte, NC (US)

(73) Assignee: BASF SE, Ludwigshafen (DE)

(21) Appl. No.: 13/813,801

(22) PCT Filed: Aug. 3, 2011
(86) PCT No.: PCT/US11/46458

§ 371 Date: Feb. 1, 2013

Related U.S. Application Data
(60) Provisional application No. 61/400,828, filed on Aug. 3, 2010.
(60) Provisional application No. 61/384,776, filed on Sep. 21, 2010.

(51) Int. Cl. C09J 131/04

(52) U.S. Cl. CPC C09J 131/04
USPC 524/72; 264/331.15

(57) ABSTRACT

A composite article comprises a plurality of lignocellulosic pieces and an adhesive system disposed on the plurality of lignocellulosic pieces for bonding the plurality of lignocellulosic pieces. The adhesive system comprises a binder component and a tackifier component. The tackifier component comprises a homo- and/or co-polymer of vinyl acetate. The tackifier component is useful for maintaining orientation of the plurality of lignocellulosic pieces during manufacture of the composite article. The composite article may be various engineered lignocellulosic composites, such as particleboard.

### CROSS-REFERENCE TO RELATED APPLICATIONS

This application claims the benefit of U.S. Provisional Patent Application No. 61/400,828, filed on Aug. 3, 2010, and the benefit of U.S. Provisional Patent Application No. 61/384,776, filed on Sep. 21, 2010, both of which are incorporated herein by reference in their entirety.

### FIELD OF THE INVENTION

The present invention generally relates to composite articles, and more specifically, to composite articles comprising a plurality of lignocellulosic pieces and an adhesive system disposed on the plurality of lignocellulosic pieces, and to methods of forming the composite articles.

### DESCRIPTION OF THE RELATED ART

Lignocellulosic composite articles, such as oriented strand board (OSB), oriented strand lumber (OSL), particleboard (PB), scrimber, agrifiber board, chipboard, flakeboard, and fiberboard, e.g. medium density fiberboard (MDF), are generally produced by blending or spraying lignocellulosic pieces with a binder composition, e.g. a resin, while the lignocellulosic pieces are tumbled or agitated in a blender or similar apparatus. After blending sufficiently to form a binder-lignocellulosic mixture, the lignocellulosic pieces, which are now coated with the binder composition, are formed into a product, specifically a loose mat, which is compressed between heated platens/plates to set the binder composition and to bond the lignocellulosic pieces together in densified form, such as in a board, panel, or other shape. Conventional processes for compressing the loose mat are generally carried out at temperatures of from about 120° C. to about 225° C., in the presence of varying amounts of steam, either purposefully injected into the loose mat or generated by liberation of entrained moisture from the lignocellulosic pieces in the loose mat. These processes also generally require that the moisture content of the lignocellulosic pieces be between about 2% and about 20% by weight, before blending the lignocellulosic pieces with the binder composition.

The lignocellulosic pieces can be in the form of chips, shavings, strands, scrim, wafers, fibers, sawdust, bagasse, straw and wood wool. When the lignocellulosic pieces are relatively larger in size, e.g. from 1 to 7 inches, the lignocellulosic composite articles produced by the process are known in the art under the general term of engineered wood. These engineered woods include laminated strand lumber, OSB, OSL, scrimber, parallel strand lumber, and laminated veneer lumber. When the lignocellulosic pieces are relatively smaller, e.g. typical sawdust and refined fiber sizes, the lignocellulosic composite articles are known in the art as particleboard (PB) and fiberboard, e.g. MDF. Other engineered woods, such as plywood, employ larger sheets of lumber, which are held together by a binder composition in a sandwich configuration. Yet other engineered woods, such as scrimber, employ thin, long, irregular pieces of wood having average diameters ranging from about 2 to 10 mm and lengths several feet in length.

The engineered woods were developed because of the increasing scarcity of suitably sized tree trunks for cutting lumber. Such engineered woods can have advantageous physical properties such as strength and stability. Another advantage of the engineered woods is that they can be made from the waste material generated by processing other wood and lignocellulosic materials. This leads to efficiencies and energy savings from the recycling process, and saves landfill space.

Binder compositions that have been used for making such lignocellulosic composite articles include phenol formaldehyde (PF) resins, urea formaldehyde (UF) resins and isocyanate resins. Binder compositions based on isocyanate chemistry are commercially desirable because they have low water absorption, high adhesive and cohesive strength, flexibility in formulation, versatility with respect to cure temperature and rate, excellent structural properties, the ability to bond with lignocellulosic materials having high water contents, and importantly, zero formaldehyde emissions.

It is known to treat lignocellulosic materials with polymethylene poly(phenyl isocyanates) (also known in the art as polymeric MDI or PMDI) to improve the strength of the composite article. Typically, such treatment involves applying the isocyanate to the lignocellulosic material and allowing the isocyanate to cure, either by application of heat and pressure or at room temperature. While it is possible to allow the PMDI to cure under ambient conditions, residual isocyanate (NCO) groups remain on the treated articles for weeks or even months in some instances. It is also known, but generally less acceptable from an environmental standpoint, to utilize toluene diisocyanate (TDI), for such purposes. Isocyanate prepolymers are among the preferred isocyanate materials that have been used in binder compositions to solve various processing problems, particularly, in reducing adhesion to press platens and for reducing reactivity of the isocyanates.

Unfortunately, disadvantages of using isocyanates in place of PF and/or UF resins include difficulty in processing due to adhesion to platens, lack of tack or cold-tack (i.e., the isocyanates are not “tacky” or “sticky”), cost, and the need for special storage in certain scenarios. For example, isocyanate resins do not impart sufficient tack to lignocellulosic pieces of PB, e.g. sawdust, while in a furnish or mat form, such that prior to complete manufacture of the PB, the furnish can distort or fall apart thus impacting final quality of the PB formed therefrom. Those in the art appreciate that furnish of PB goes through many transitions prior to complete manufacture of the PB, and such transitions expose furnish to distortion. Distortion can vary from site to site, based on differences in equipment, layout, etc. Therefore, various levels of tack are required based on such differences.

Accordingly, there remains an opportunity to provide lignocellulosic furnishes/mats with improved tack thereby imparting composite articles formed therefrom with improved physical properties. There also remains an opportunity to provide a method of forming such composite articles.

### SUMMARY OF THE INVENTION AND ADVANTAGES

A composite article comprises a plurality of lignocellulosic pieces and an adhesive system disposed on the plurality of lignocellulosic pieces for bonding the plurality of lignocellulosic pieces. The adhesive system comprises a binder component and a tackifier component. The tackifier component comprises a homo- and/or co-polymer of vinyl acetate.

The tackifier component of the present invention is useful for maintaining orientation of the plurality of lignocellulosic pieces during manufacture of the composite article. As such, throughput of the composite articles can be increased via increased manufacturing speeds, e.g. press speeds. Other manufacturing benefits can also be realized, such as improved application of the components of the adhesive system to the plurality of lignocellulosic pieces relative to conventional adhesives. In addition, it is believed that the composite articles formed according to the present invention include excellent physical properties. For example, in certain embodiments, the composite articles of the present invention can have one or more of the following: increased bond strength, reduced edge swelling, improved release properties, improved flexural modulus, and/or reduced emissions, each relative to conventional composite articles.

### DETAILED DESCRIPTION OF THE INVENTION

The present invention provides a composite article, and more specifically, a lignocellulosic composite article. The composite article can be used for various applications. Examples of such applications include, but are not limited to, for packaging; for furniture and cabinetry; for roof and floor sheathing; for roof, floor, and siding paneling; for window and door frames; and for webstock, e.g. webstock for engineered I-beams.

The composite article, in various embodiments, can be referred to as various forms of engineered lignocellulosic composites, e.g., as engineered wood composites, such as oriented strand board (OSB); oriented strand lumber (OSL); scrimber; fiberboard, such as low density fiberboard (LDF), medium density fiberboard (MDF), and high density fiberboard (HDF); chipboard; flakeboard or flake board; particleboard (PB); plywood; etc. Generally, the composite article is in the form OSB, OSL, PB, scrimber, plywood, LDF, MDF, or HDF, more typically in the form of PB; however, it is to be appreciated that composite article may be in other engineered wood forms, such as, but not limited to, those described and exemplified herein. It is to be appreciated that the names of lignocellulosic composite articles are often used interchangeably in the art. For example, one may refer to a composite as OSB whereas another may refer to the same composite as flake board.

The composite article of the present invention comprises a plurality of lignocellulosic pieces. The lignocellulosic pieces can be derived from a variety of lignocellulosic materials. Generally, the lignocellulosic pieces are derived from wood; however, the lignocellulosic pieces can be derived from other lignocellulosic materials, such as from bagasse, straw, flax residue, nut shells, cereal grain hulls, etc., and mixtures thereof. If wood is employed as the lignocellulosic material, the lignocellulosic pieces can be prepared from various species of hardwoods and/or softwoods, as understood in the art. Non-lignocellulosic materials in flake, fibrous or other particulate form, such as glass fiber, mica, asbestos, rubber, plastics, etc., can also be mixed with the lignocellulosic material; however, such materials are not generally required for purposes of the present invention.

The lignocellulosic pieces can come from a variety of processes, such as by comminuting small logs, industrial wood residue, branches, rough pulpwood, etc. into pieces in the form of sawdust, chips, flakes, wafer, strands, scrim, fibers, sheets, etc. In certain embodiments, the lignocellulosic pieces comprise those pieces typically employed for forming OSB, OSL, scrimber, and particleboards (PB). In other embodiments, the lignocellulosic pieces comprise those pieces typically employed for forming fiberboards, such as LDF, MDF, and HDF. In yet another embodiment the lignocellulosic pieces comprise those pieces typically employed for forming plywood. It is to be appreciated that the composite article of the present invention can include various combinations of the aforementioned materials and/or pieces, such as strands and sawdust. In addition, the composite article may be formed into shapes other than panels and boards.

As introduced above, the lignocellulosic pieces can be produced by various conventional techniques. For example, pulpwood grade logs can be converted into flakes in one operation with a conventional roundwood flaker. Alternatively, logs and logging residue can be cut into fingerlings on the order of from about 0.5 to about 3.5 inches long with a conventional apparatus, and the fingerlings flaked in a conventional ring type flaker. As understood in the art, the logs are typically debarked before flaking. It is to be appreciated that the present invention is not limited to any particular method of forming the lignocellulosic pieces.

The dimensions of the lignocellulosic pieces are not particularly critical for purposes of the present invention. In certain embodiments, such as those used to form OSB, the lignocellulosic pieces typically comprise strands having an average length of from about 2.5 to about 6 inches, an average width of from about 0.5 to about 2 inches, and an average thickness of from about 0.1 to about 0.5 inches. It is to be appreciated that other sizes can also be employed, as desired by one skilled in the art. In some of these embodiments, the composite article may include other types of lignocellulosic pieces, such as chips, in addition to the strands. In certain embodiments, strands which are typically about 1.5 inches wide and about 12 inches long can be used to make laminated strand lumber, while strands typically about 0.12 inches wide and about 9.8 inches long can be used to make parallel strand lumber. In certain embodiments, such as those used to form flakeboard, the lignocellulosic pieces comprise flakes having an average length of from about 2 to about 6 inches, an average width of about 0.25 to about 3 inches, and an average thickness of from about 0.005 to about 0.05 inches. In other embodiments, such as those used to from scrimber, the lignocellulosic pieces comprise thin, irregular pieces having average diameters ranging from about 0.25 to about 20, alternatively from about 0.5 to about 15, alternatively from about 1 to about 10, mm, and lengths ranging from several inches to several feet in length. Detailed information on suitable sizes and shapes of lignocellulosic pieces, e.g., scrim, as well as methods of manufacturing scrimber, for purposes of the present invention, is described in U.S. Pat. No. 6,344,165 to Coleman, the disclosure of which is incorporated herein by reference in its entirety. In yet other embodiments, the lignocellulosic pieces are those typically used to form conventional PB. The lignocellulosic pieces can be further milled prior to use, if such is desired to produce a size more suitable for producing a desired article. For example, hammer, wing beater, and toothed disk mills may be used for forming lignocellulosic pieces of various sizes and shapes.

The lignocellulosic pieces can have various moisture contents, where if present, water can serve as an isocyanate-reactive component, which is described further below. Typically, the lignocellulosic pieces have a moisture content of from about 1 to about 20, alternatively from about 2 to about 15, alternatively from about 3 to about 12, alternatively from about 5 to about 10, parts by weight (water), each based on 100 parts by weight of the lignocellulosic pieces. If present in (or on) the lignocellulosic pieces, the water assists in the curing or setting of the composite article, as understood by those skilled in the art. It is to be appreciated that the lignocellulosic pieces can have inherent moisture content; or alternatively, water may be added to or removed from the lignocellulosic pieces, such as by wetting or drying the lignocellulosic pieces, respectively, to obtain a desired moisture content of the lignocellulosic pieces prior to and/or during formation of the composite article.

The lignocellulosic pieces are utilized in the composite article in various amounts, depending on the type of composite article desired to be formed. Typically, such as in OSB, PB, scrimber, or MDF applications, the lignocellulosic pieces are utilized in an amount of from about 75 to about 99, alternatively from about 85 to about 98, alternatively from about 90 to about 97, alternatively from about 92 to about 95.5, parts by weight, each based on 100 parts by weight of the composite article. It is to be appreciated that the amounts described immediately above can be higher or lower depending on various factors, including moisture content of the lignocellulosic pieces. For example, moisture content of the lignocellulosic pieces can vary by geographic location, source, etc., such as variations from mill to mill.

The composite article further comprises an adhesive system. The adhesive system is disposed on the lignocellulosic pieces for bonding the lignocellulosic pieces. By “disposed on”, it is meant that the adhesive system is in contact with at least a portion of the lignocellulosic pieces. The adhesive system comprises a binder component and a tackifier component. The adhesive system may comprise one or more additional components, as described below. The adhesive is generally formed from the binder component and the tackifier component. It is to be a appreciated that in certain embodiments, the binder and the tackifier components may react (with one another and/or with another component), such that they may only exist for a period of time during formation of the composite article. For example, most to all of the binder component may be reacted during formation of the composite article such that little to no binder component remains in the composite article after formation. In other embodiments, some amount of the binder component and/or the tackifier component may be present in the composite article after formation.

The binder component is typically selected from the group of an isocyanate component, a formaldehyde resin, a protein-based adhesive, or a combination thereof. If employed, the isocyanate component is typically a polymeric diphenylmethane diisocyanate (pMDI), however, other isocyanates can also be employed as described below. If employed, the formaldehyde resin is typically a urea formaldehyde (UF) resin or a melamine UF resin, however, other formaldehydes can also be used, e.g. a phenol formaldehyde (PF) resin. If employed, the protein-based adhesive is typically a soy-based adhesive, however, other protein-based adhesives can also be employed, e.g. a casein-based adhesive.

As introduced above, in general, the binder component is only present for some amount of time prior to a reaction product thereof curing to a final cured state to form the adhesive system, and therefore, the composite article. In other words, the reaction product is generally the final cured state of the adhesive system, after reaction occurs between the components used to form the composite article, e.g. after reaction between the isocyanate component and an isocyanate-reactive component (described below).

Components of the adhesive can be premixed or combined to form the adhesive system and then the adhesive system can be applied to the lignocellulosic pieces. More typically, the binder component, the tackifier component, and optionally, one or more additional components, are individually applied to the lignocellulosic pieces, and/or already present thereon, during formation of the composite article, rather then being premixed and applied, all of which is further described below.

As understood to those skilled in the art, the binder component generally adheres the lignocellulosic pieces to one another, once cured. For example, the reaction product of the isocyanate component and the isocyanate-reactive component can bond the lignocellulosic pieces via linkages, e.g. urea linkages. The tackifier component may also partially react, such that it too is part of the reaction product, or may be inert such that it is not part of the reaction product (albeit it may be present therein). General mechanisms of adhesion, for wood composites, are detailed in pages 397 through 399 of THE POLYURETHANES HANDBOOK (David Randall & Steve Lee eds., John Wiley & Sons, Ltd. 2002), the disclosure of which is incorporated herein by reference in its entirety.

As alluded to above, in a first embodiment of the binder component, the adhesive system comprises the reaction product of the isocyanate component and the isocyanate-reactive component reactive with the isocyanate component. The isocyanate component is typically a polyisocyanate having two or more functional groups, e.g. two or more isocyanate (NCO) groups. Said another way, the isocyanate component can just be an isocyanate or a combination of isocyanates. Suitable organic polyisocyanates, for purposes of the present invention include, but are not limited to, conventional aliphatic, cycloaliphatic, araliphatic and aromatic isocyanates. In certain embodiments, the isocyanate component is selected from the group of diphenylmethane diisocyanates (MDIs), polymeric diphenylmethane diisocyanates (PMDIs), and combinations thereof. Polymeric diphenylmethane diisocyanates are also referred to in the art as polymethylene polyphenylene polyisocyanates. In other embodiments, the isocyanate component is an emulsifiable MDI (eMDI). Examples of other suitable isocyanates, for purposes of the present invention include, but are not limited to, toluene diisocyanates (TDIs), hexamethylene diisocyanates (HDIs), isophorone diisocyanates (IPDIs), naphthalene diisocyanates (NDIs), and combinations thereof.

In certain embodiments, the isocyanate component is an isocyanate-terminated prepolymer. The isocyanate-terminated prepolymer is a reaction product of an isocyanate and a polyol and/or a polyamine. The isocyanate may be any type of isocyanate known to those skilled in the polyurethane art, such as one of the polyisocyanates described above. If employed to make the isocyanate-terminated prepolymer, the polyol is typically selected from the group of ethylene glycol, diethylene glycol, propylene glycol, dipropylene glycol, butane diol, glycerol, trimethylolpropane, triethanolamine, pentaerythritol, sorbitol, and combinations thereof. The polyol may also be a polyol as described and exemplified further below with discussion of the isocyanate-reactive component. If employed to make the isocyanate-terminated prepolymer, the polyamine is typically selected from the group of ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof. It is to be appreciated that the isocyanate-terminated prepolymer may be formed from a combination of two or more of the aforementioned polyols and/or polyamines.

As alluded to above, the isocyanates or isocyanate-terminated prepolymers may also be used in the form of an aqueous emulsion by mixing such materials with water in the presence of an emulsifying agent. The isocyanate component may also be a modified isocyanate, such as, carbodiimides, allophanates, isocyanurates, and biurets.

Other suitable isocyanates, for purposes of the present invention, include those described in U.S. Pat. Nos. 4,742,113 to Gismondi et al.; 5,093,412 to Mente et al.; 5,425,976 to Clarke et al.; 6,297,313 to Hsu; 6,352,661 to Thompson et al.; 6,451,101 to Mente et al.; 6,458,238 to Mente et al.; 6,464,820 to Mente et al.; 6,638,459 to Mente et al.; 6,649,098 to Mente et al.; 6,822,042 to Capps; and 6,846,849 to Capps; and U.S. Publication Nos. 2003/0047278 to Mente et al.; 2005/0221078 to Lu et al.; 2005/0242459 to Savino et al.; and 2006/0157183 to Evers et al.; the disclosures of which are incorporated herein by reference in their entirety to the extent they do not conflict with the general scope of the present invention.

Specific examples of suitable isocyanate components, for purposes of the present invention, are commercially available from BASF Corporation of Florham Park, N.J., under the trademark LUPRANATE®, such as LUPRANATE® M, LUPRANATE® MI, LUPRANATE® M20SB, LUPRANATE® M20HB, and LUPRANATE® M20FB isocyanates. In one embodiment, the isocyanate component is LUPRANATE® M20FB. It is to be appreciated that the isocyanate component may include any combination of the aforementioned isocyanates and/or isocyanate-terminated prepolymers.

If employed, the isocyanate component typically has a viscosity which is suitable for specific applications of the isocyanate component to the lignocellulosic pieces, such as by spraying, fogging and/or atomizing the isocyanate component to apply the isocyanate component to the lignocellulosic pieces. Typically, the isocyanate component has a viscosity of from about 100 to about 5,000, alternatively from about 100 to about 2,500, alternatively from about 100 to about 1,000, cps at 25° C. according to ASTM D2196. Regardless of the application technique, the viscosity of the isocyanate component should be sufficient to adequately coat the lignocellulosic pieces.

As introduced above, the adhesive system can comprise the reaction product of the isocyanate component and the isocyanate-reactive component. In one embodiment, the isocyanate-reactive component is water, which may be applied to and/or already present on the lignocellulosic pieces, e.g. as a portion of a preexisting moisture content, as described above. In other embodiments, the isocyanate-reactive component comprises a polyol and/or a polyamine. In certain embodiments, the isocyanate-reactive component comprises a graft polyol. It is to be appreciated that the isocyanate-reactive component can comprise a combination of the aforementioned isocyanate-reactive components.

Typically, such as in OSB, PB, scrimber, or MDF applications, the isocyanate-reactive component is utilized in an amount of from about 1 to about 20, alternatively from about 1 to about 15, alternatively from about 2 to about 10, parts by weight, each based on 100 parts by weight of lignocellulosic pieces. It is to be appreciated that the amounts described herein are generally based on the assumption that the lignocellulosic pieces are completely dry to account for variations in moisture contents of the lignocellulosic pieces. More specific amounts are described below. It is to be appreciated that if water is utilized at the isocyanate-reactive component, it can be present in these amounts of in the amounts described above regarding moisture content of the lignocellulosic pieces.

If employed, the polyol is typically selected from the group of conventional polyols, such as ethylene glycol, diethylene glycol, propylene glycol, dipropylene glycol, butane diol, glycerol, trimethylolpropane, triethanolamine, pentaerythritol, sorbitol, and combinations thereof. Other suitable polyols include, but are not limited to, biopolyols, such as soybean oil, castor-oil, soy-protein, rapeseed oil, etc., and combinations thereof. It is believed that certain polyols impart plasticization and/or film formation, and tackiness, which may increase with pressure. For example, some polyols may act as a plasticizer, especially in conjunction with the tackifier component.

Suitable polyether polyols, for purposes of the present invention include, but are not limited to, products obtained by the polymerization of a cyclic oxide, for example ethylene oxide (EO), propylene oxide (PO), butylene oxide (BO), or tetrahydrofuran in the presence of polyfunctional initiators. Suitable initiator compounds contain a plurality of active hydrogen atoms, and include water, butanediol, ethylene glycol, propylene glycol (PG), diethylene glycol, triethylene glycol, dipropylene glycol, ethanolamine, diethanolamine, triethanolamine, toluene diamine, diethyl toluene diamine, phenyl diamine, diphenylmethane diamine, ethylene diamine, cyclohexane diamine, cyclohexane dimethanol, resorcinol, bisphenol A, glycerol, trimethylolpropane, 1,2,6-hexanetriol, pentaerythritol, and combinations thereof.

Other suitable polyether polyols include polyether diols and triols, such as polyoxypropylene diols and triols and poly(oxyethylene-oxypropylene)diols and triols obtained by the simultaneous or sequential addition of ethylene and propylene oxides to di- or trifunctional initiators. Copolymers having oxyethylene contents of from about 5 to about 90% by weight, based on the weight of the polyol component, of which the polyols may be block copolymers, random/block copolymers or random copolymers, can also be used. Yet other suitable polyether polyols include polytetramethylene glycols obtained by the polymerization of tetrahydrofuran.

Suitable polyester polyols, for purposes of the present invention include, but are not limited to, hydroxyl-terminated reaction products of polyhydric alcohols, such as ethylene glycol, propylene glycol, diethylene glycol, 1,4-butanediol, neopentylglycol, 1,6-hexanediol, cyclohexane dimethanol, glycerol, trimethylolpropane, pentaerythritol or polyether polyols or mixtures of such polyhydric alcohols, and polycarboxylic acids, especially dicarboxylic acids or their ester-forming derivatives, for example succinic, glutaric and adipic acids or their dimethyl esters sebacic acid, phthalic anhydride, tetrachlorophthalic anhydride or dimethyl terephthalate or mixtures thereof. Polyester polyols obtained by the polymerization of lactones, e.g. caprolactone, in conjunction with a polyol, or of hydroxy carboxylic acids, e.g. hydroxy caproic acid, may also be used.

Suitable polyesteramides polyols, for purposes of the present invention, may be obtained by the inclusion of aminoalcohols such as ethanolamine in polyesterification mixtures. Suitable polythioether polyols, for purposes of the present invention, include products obtained by condensing thiodiglycol either alone or with other glycols, alkylene oxides, dicarboxylic acids, formaldehyde, aminoalcohols or aminocarboxylic acids. Suitable polycarbonate polyols, for purposes of the present invention, include products obtained by reacting diols such as 1,3-propanediol, 1,4-butanediol, 1,6-hexanediol, diethylene glycol or tetraethylene glycol with diaryl carbonates, e.g. diphenyl carbonate, or with phosgene. Suitable polyacetal polyols, for purposes of the present invention, include those prepared by reacting glycols such as diethylene glycol, triethylene glycol or hexanediol with formaldehyde. Other suitable polyacetal polyols may also be prepared by polymerizing cyclic acetals. Suitable polyolefin polyols, for purposes of the present invention, include hydroxy-terminated butadiene homo- and copolymers and suitable polysiloxane polyols include polydimethylsiloxane diols and triols.

Specific examples of suitable polyols, for purposes of the present invention, are commercially available from BASF Corporation under the trademark of PLURACOL®. It is to be appreciated that the prepolymer component may include any combination of two or more of the aforementioned polyols.

In one embodiment employing the graft polyol, the graft polyol is a polymer polyol. In other embodiments, the graft polyol is selected from the group of polyharnstoff (PHD) polyols, polyisocyanate polyaddition (PIPA) polyols, and combinations thereof. It is to be appreciated that the isocyanate-reactive component can comprise any combination of the aforementioned graft polyols. Graft polyols may also be referred to in the art as graft dispersion polyols or graft polymer polyols. Graft polyols are well known to those skilled in the polyurethane art and include products, i.e., polymeric particles, obtained by the in-situ polymerization of one or more vinyl monomers, e.g. styrene monomers and/or acrylonitrile monomers, and a macromer in a polyol, e.g. a polyether polyol. In one embodiment, the isocyanate-reactive component is a styrene-acrylonitrile graft polyol. PHD polyols are typically formed by in-situ reaction of a diisocyanate with a diamine in a polyol to give a stable dispersion of polyurea particles. PIPA polyols are similar to PHD polyols, except that the dispersion is typically formed by in-situ reaction of a diisocyanate with an alkanoamine instead of a diamine, to give a polyurethane dispersion in a polyol. It is to be appreciated that the present invention is not limited to any particular method of making the graft polyol.

If employed, the graft polyol can serve as a sizing agent substitute, e.g. a sizing wax or wax sizing agent substitute, specifically by imparting a certain degree of water repellency to the composite article, once formed. Paraffin, for example, is a common wax sizing agent for OSB and OSL applications. In certain embodiments, the composite article is substantially free of a wax component, such as paraffin. By “substantially free”, it is meant that in these embodiments, the wax component is typically present in an amount no greater than about 5, alternatively no greater than about 2.5, alternatively no greater than about 1.5, alternatively approaching or equaling 0, parts by weight, each based on 100 parts by weight of the lignocellulosic pieces. In certain embodiments, the composite article is completely free of a wax component.

One method by which the graft polyol of the present invention imparts water repellency is by at least partially coating a surface of the lignocellulosic pieces, thus decreasing surface tension of the surface. Another method by which the graft polyol imparts water repellency is that the graft polyol at least partially fills capillaries within and between the lignocellulosic pieces, thus providing a barrier to capillary uptake of water. Further, it is believed that the graft polyol reduces formation of micro- and/or nano-cracks from forming within the composite article, for example, within the adhesive, during or after cure to form the reaction product. Yet further, if such cracks are already present in the lignocellulosic pieces, the graft polyol at least partially fills such cracks, as alluded to above with description of the capillaries. It is believed that the blocking of water and filling of cracks reduces de-lamination and swelling problems when the composite article is exposed to moisture during use. It is further believed that such “filling” largely occurs due to the polymeric particles of the graft polyol.

If employed, the graft polyol comprises a continuous phase and a discontinuous phase, more typically the graft polyol includes the continuous phase and the discontinuous phase. The continuous phase of the graft polyol is not generally miscible with the isocyanate component, which provides for increased coverage of the polymeric particles with reactive groups, such as hydroxyl (OH) groups. Such reactive groups can further impart crosslinking in the composite article, once the reactive groups are reacted. The polymeric particles are further described below.

In certain embodiments, the polyol of the graft polyol is a hydrophobic polyol. In a specific embodiment, the polyol is a hydrophobic polyether polyol. In another specific embodiment, the polyol is a hydrophobic polyester polyol. The hydrophobic polyol contains alkylene oxides. In these embodiments, the hydrophobic polyol typically has from about 0 to about 50, alternatively from about 2 to about 20, alternatively from about 5 to about 15, parts by weight of ethylene oxide (EO), each based on 100 parts by weight of the alkylene oxides of the hydrophobic polyol. In other embodiments, the hydrophobic polyol typically has at least 60, alternatively at least 70, alternatively at least 80, parts by weight propylene oxide (PO), each based on 100 parts by weight of the alkylene oxides. Accordingly, in these embodiments, the hydrophobic polyol is a propylene oxide rich polyol, which imparts the hydrophobic polyol with hydrophobicity, and therefore further imparts the composite article with hydrophobicity.

In certain embodiments, the alkylene oxides of the hydrophobic polyol comprise a mixture of ethylene oxide and propylene oxide. In another embodiment, the alkylene oxides of the hydrophobic polyol include only propylene oxide, i.e., the hydrophobic polyol does not include other alkylene oxides, such as ethylene oxide. In certain embodiments, the hydrophobic polyol comprises other types of alkylene oxides known in the art, e.g. butylene oxide (BO), in combination with propylene oxide, and optionally, in combination with ethylene oxide. The alkylene oxides of the hydrophobic polyol may be arranged in various configurations, such as a random (heteric) configuration, a block configuration, a capped configuration, or a combination thereof. For example, in one embodiment, the hydrophobic polyol comprises a heteric mixture of ethylene oxide and propylene oxide.

In certain embodiments, the hydrophobic polyol is terminally capped with ethylene oxide. The hydrophobic polyol typically has a terminal cap of from about 5 to about 25, alternatively from about 5 to about 20, alternatively from about 10 to about 15, parts by weight ethylene oxide, each based on 100 parts by weight of the hydrophobic polyol. It is to be appreciated that in certain embodiments, the ethylene oxide may only be present in the terminal ethylene oxide cap; however, in other embodiments, the ethylene oxide may also be present along with the propylene oxide, and optionally, with other alkylene oxides, e.g. butylene oxide, in the alkylene oxides of the hydrophobic polyol. Generally, for purposes of the present invention, increased propylene oxide content of the hydrophobic polyol is preferred in order to impart increased hydrophobicity to the composite article.

Suitable hydrophobic polyols, for purposes of the present invention include, but are not limited to, glycerine-initiated, trimethylolpropane-initiated, propylene glycol-initiated, and sucrose-initiated polyether polyols, and combinations thereof. In one embodiment, the hydrophobic polyol is a glycerine-initiated polyether polyol. The alkylene oxides of the hydrophobic polyol generally extend from the respective initiator portion of the hydrophobic polyol.

As alluded to above, the discontinuous phase of the graft polyol comprises polymeric particles. As introduced above, if micro- and/or nano-cracks are present in the lignocellulosic pieces, it is believed that the polymeric particles of the discontinuous phase of the graft polyol at least partially fill these cracks. The polymeric particles are generally large in size due to their macromer constituents, i.e., the polymeric particles have micrometer or larger dimensions, e.g. micrometer or larger diameters. In certain embodiments, the polymeric particles have average diameters ranging from about 0.1 to about 10 microns, alternatively from about 0.1 to about 1.5 microns. In other embodiments, the polymeric particles have average diameters less than 0.1 microns, which imparts the graft polyol with nano-polymeric particles. Blocking of water and filling of cracks reduces de-lamination and swelling problems when the composite article is exposed to moisture during storage or use. In addition to filling cracks, in certain embodiments, the polymeric particles are reactive with the isocyanate component, which may increase internal bond (IB) strength of the composite article. As introduced above, the polymeric particles typically comprise the reaction product of monomers selected from the group of styrenes, e.g. alpha-methyl styrene, acrylonitriles, esters of acrylic and methacrylic acids, ethylenically unsaturated nitriles, amines, amides, and combinations thereof. In certain embodiments, the polymeric particles comprise the further reaction of a macromer, such as a polyol having an unsaturation, which permits chemical incorporation of the polymeric particle, as described above. In these embodiments, it is believed that the polymeric particles can impart crosslinking in the composite article, due to reactive groups attached to the polymeric particles, e.g. OH groups, which can react with the isocyanate component. It is also believed that the polymeric particles can serve as a “hot melt” adhesive depending on their specific chemical makeup, e.g. polymeric particles formed from styrene and acrylonitrile monomers.

In one embodiment, the polymeric particles comprise styrene acrylonitrile (SAN) copolymers, which are the reaction product of styrene monomers and acrylonitrile monomers, as understood in the art. Typically, the SAN copolymers have a weight ratio of styrene to acrylonitrile of from about 30:70 to about 70:30, alternatively from about 40:60 to about 60:40, alternatively from about 45:55 to about 60:40, alternatively from about 50:50 to about 60:40, alternatively from about 55:45 to about 60:40. In one embodiment, the SAN copolymers have a weight ratio of styrene to acrylonitrile of about 66.7:33.3. In another embodiment, the polymeric particles are urea, which are the reaction product of an amine monomer and an isocyanate (NCO) group, such as an NCO group of a diisocyanate. In yet another embodiment, the polymeric particles are urethane, which are the reaction product of an alcohol monomer and an isocyanate (NCO) group, such as an NCO group of a diisocyanate.

Typically, the polymeric particles are present in the graft polyol in an amount of from about 5 to about 70, alternatively from about 15 to about 55, alternatively from about 25 to about 50, parts by weight, based on 100 parts by weight of the graft polyol. In one embodiment, the polymeric particles are present in the graft polyol in an amount of about 65 parts by weight based on 100 parts by weight of the graft polyol. Generally, increasing the amount of polymeric particles increases the water repellency of the composite article, as like described above.

The graft polyol typically has a molecular weight of from about 400 to about 20,000, alternatively from about 500 to about 10,000, alternatively from about 600 to about 5,000, alternatively from about 700 to about 3,000. In one embodiment, the graft polyol has a molecular weight of about 730. In another embodiment, the graft polyol has a molecular weight of about 3,000.

Other suitable graft polyols and methods of making the same, for purposes of the present invention, include those described in U.S. Pat. Nos. 4,522,976 to Grace et al.; 5,093,412 to Mente et al.; 5,179,131 to Wujcik et al.; 5,223,570 to Huang et al.; 5,594,066 to Heinemann et al.; 5,814,699 to Kratz et al.; 6,034,146 to Falke et al.; 6,103,140 to Falke et al.; 6,352,658 to Chang et al.; 6,432,543 to Harrison et al.; 6,472,447 to Lorenz et al.; 6,649,107 to Harrison et al.; and 7,179,882 to Adkins et al., the disclosures of which are incorporated herein by reference in their entirety.

Specific examples of suitable graft polyols, for purposes of the present invention, are commercially available from BASF Corporation, under the trademark PLURACOL®, such as PLURACOL® 1365, PLURACOL® 4600, PLURACOL® 4650, PLURACOL® 4800, PLURACOL® 4815, PLURACOL® 4830, and PLURACOL® 4850 graft polyols. In a specific embodiment, the isocyanate component comprises PLURACOL® 4650. In another embodiment, the isocyanate component is PLURACOL® 2086 and/or PLURACOL® 593. It is to be appreciated that the isocyanate-reactive component may include any combination of the aforementioned graft polyols. Detailed information on graft polyols is described on pages 104 and 105 of THE POLYURETHANES HANDBOOK (David Randall & Steve Lee eds., John Wiley & Sons, Ltd. 2002), which are incorporated herein in their entirety.

If employed, the graft polyol typically has a viscosity which is suitable for specific applications of the graft polyol to the lignocellulosic pieces, such as by spraying, fogging and/or atomizing the graft polyol to apply the graft polyol to the lignocellulosic pieces. Typically, the graft polyol has a viscosity of from about 100 to about 10,000, alternatively from about 500 to about 5,000, alternatively from about 500 to about 3,000, cps at 25° C. according to ASTM D2196. Regardless of application technique, the viscosity of the graft polyol should be sufficient to adequately coat the lignocellulosic pieces.

If employed, the graft polyol is typically utilized in an amount of from about 5 to about 40, alternatively from about 10 to about 30, alternatively from about 15 to about 25, parts by weight, each based on 100 parts by weight of the adhesive system. It is to be appreciated that the graft polyol may include any combination of the aforementioned polyols, polymeric particles, and/or types of graft polyols.

As alluded to above, the adhesive system may further comprise an auxiliary polyol, different than the polyol in the graft polyol, if the isocyanate component is employed as the binder component. Suitable polyols for use as the auxiliary polyol are as described and exemplified above with description of the isocyanate-terminated prepolymer. The auxiliary polyol can be used for various purposes. For example, an auxiliary polyol having a higher functionality (relative to the polyol of the graft polyol) can be employed to provide additional reactive groups for reaction with the isocyanate component, or an auxiliary polyol can be employed to increase or decrease viscosity of the adhesive. If employed, the auxiliary polyol may be utilized in various amounts.

In a second embodiment of the binder component, the binder component of the adhesive system comprises a UF resin or a melamine UF resin. The UF resin may be any type of UF resin or melamine UF resin known in the art. Suitable grades of UF resins and melamine UF resins, for purposes of the present invention, are commercially available from a variety of suppliers, such as Hexion Specialty Chemicals Inc. of Springfield, Oreg. An example of a suitable UF resin, for purposes of the present invention, is Casco-Resin F09RFP from Hexion.

In a third embodiment of the binder component, the binder component of the adhesive system is a soy-based adhesive. As understood in the art, soy-based adhesives typically comprise soy flour which may or may not be modified. The soy-based adhesive can be in the form of a dispersion. The soy can have various functional groups, such as lysine, histidine, arginine, tyrosine, tryptophan, serine, and/or cysteine. Each group, if present, can range from about 1% to about 8% by weight based on the soy itself. In certain embodiments, the soy flour may be copolymerized, such as with PF, UF, pMDI, etc. Suitable soy-based adhesives, for purposes of the present invention, are described in: Wood adhesives 2005: Nov. 2-4, 2005 . . . San Diego, Calif., USA. Madison, Wis.: Forest Products Society, 2005: ISBN: 1892529459: pages 263-269; and at http://www.forestprod.org/adhesives09allen.pdf; which are incorporated by reference in their entirety.

In certain embodiments, the soy-based adhesive comprises a combination of polyamidoamine-epi-chlorohydrin (PAE) resin and soy adhesive. The PAE resin and soy adhesive may be used in various ratios, typically with a greater amount of soy adhesive being present relative to the amount of PAE resin. Suitable grades of PAE and soy adhesives, for purposes of the present invention, are commercially available from Hercules Incorporated of Wilmington, Del., such as Hercules® PTV D-41080 Resin (PAE) and PTV D-40999 Soy Adhesive. In one embodiment, the binder component comprises a combination of the aforementioned PAE resin and soy adhesive.

Typically, such as in OSB, PB, scrimber, or MDF applications, the binder component is utilized in an amount of from about 1 to about 20, alternatively from about 1 to about 15, alternatively from about 2 to about 10, parts by weight, each based on 100 parts by weight of the lignocellulosic pieces.

In one embodiment, the isocyanate component is utilized in an amount of about 3 parts by weight based on 100 parts by weight of the lignocellulosic pieces. In another embodiment, the UF resin is utilized in an amount of about 5 to about 10 parts by weight based on 100 parts by weight of the lignocellulosic pieces. In another embodiment, the soy-based adhesive is utilized in an amount of about 7 to about 8 parts by weight based on 100 parts by weight of the lignocellulosic pieces. Generally, when too little of the binder component is employed, the resulting composite article does not have the necessary physical properties to be commercially successful. Likewise, when too much of the binder component is employed, cost of manufacturing the composite article generally increases beyond any imparted benefits of employing such amounts of the binder component.

The adhesive system may further comprise an additive component. If employed, the additive component is typically selected from the group of parting agents, sizing agents, catalysts, fillers, flame retardants, plasticizers, stabilizers, cross-linking agents, chain-extending agents, chain-terminating agents, air releasing agents, wetting agents, surface modifiers, foam stabilizing agents, moisture scavengers, desiccants, viscosity reducers, reinforcing agents, dyes, pigments, colorants, anti-oxidants, compatibility agents, ultraviolet light stabilizers, thixotropic agents, anti-aging agents, lubricants, coupling agents, solvents, rheology promoters, adhesion promoters, thickeners, smoke suppressants, anti-static agents, anti-microbial agents, fungicides, insecticides, and combinations thereof. If employed, the additive component may be utilized in various amounts.

Other suitable additives, for purposes of the present invention, include those described in U.S. Publication No. 2006/0065996 to Kruesemann et al., the disclosure of which is incorporated herein by reference in its entirety. It is to be appreciated that the additive component may include any combination of the aforementioned additives.

In certain embodiments, the additive component comprises a catalyst component. In one embodiment, the catalyst component comprises a tin catalyst. Suitable tin catalysts, for purposes of the present invention, include tin(II) salts of organic carboxylic acids, e.g. tin(II) acetate, tin(II) octoate, tin(II) ethylhexanoate and tin(II) laurate. In one embodiment, the organometallic catalyst comprises dibutyltin dilaurate, which is a dialkyltin(IV) salt of an organic carboxylic acid. Specific examples of suitable organometallic catalyst, e.g. dibutyltin dilaurates, for purposes of the present invention, are commercially available from Air Products and Chemicals, Inc. of Allentown, Pa., under the trademark DABCO®. The organometallic catalyst can also comprise other dialkyltin(IV) salts of organic carboxylic acids, such as dibutyltin diacetate, dibutyltin maleate and dioctyltin diacetate.

Examples of other suitable catalysts, for purposes of the present invention, include iron(II) chloride; zinc chloride; lead octoate; tris(dialkylaminoalkyl)-s-hexahydrotriazines including tris(N,N-dimethylaminopropyl)-s-hexahydrotriazine; tetraalkylammonium hydroxides including tetramethylammonium hydroxide; alkali metal hydroxides including sodium hydroxide and potassium hydroxide; alkali metal alkoxides including sodium methoxide and potassium isopropoxide; and alkali metal salts of long-chain fatty acids having from 10 to 20 carbon atoms and/or lateral OH groups.

Further examples of other suitable catalysts, specifically trimerization catalysts, for purposes of the present invention, include N,N,N-dimethylaminopropylhexahydrotriazine, potassium, potassium acetate, N,N,N-trimethyl isopropyl amine/formate, and combinations thereof. A specific example of a suitable trimerization catalyst is commercially available from Air Products and Chemicals, Inc. under the trademark POLYCAT®.

Yet further examples of other suitable catalysts, specifically tertiary amine catalysts, for purposes of the present invention, include dimethylaminoethanol, dimethylaminoethoxyethanol, triethylamine, N,N,N′,N′-tetramethylethylenediamine, N,N-dimethylaminopropylamine, N,N,N′,N′,N″-pentamethyldipropylenetriamine, tris(dimethylaminopropyl)amine, N,N-dimethylpiperazine, tetramethylimino-bis(propylamine), dimethylbenzylamine, trimethylamine, triethanolamine, N,N-diethyl ethanolamine, N-methylpyrrolidone, N-methylmorpholine, N-ethylmorpholine, bis(2-dimethylamino-ethyl)ether, N,N-dimethylcyclohexylamine (DMCHA), N,N,N′,N′,N″-pentamethyldiethylenetriamine, 1,2-dimethylimidazole, 3-(dimethylamino)propylimidazole, and combinations thereof. Specific examples of suitable tertiary amine catalysts are commercially available from Air Products and Chemicals, Inc. under the trademark POLYCAT®.

If employed, the catalyst component can be utilized in various amounts. It is to be appreciated that the catalyst component may include any combination of the aforementioned catalysts.

In certain embodiments, the composite article is substantially free of UF resin and/or PF resin. By “substantially free”, it is meant that in these embodiments, the UF resin and/or PF resin is present in an amount no greater than about 15, alternatively no greater than about 10, alternatively no greater than about 5, alternatively approaching or equaling 0, parts by weight, each based on 100 parts by weight of the composite article. In other embodiments, the composite article is completely free of UF resin and/or PF resin.

As introduced above, the adhesive system also includes the tackifier component, such that the composite article further comprises the tackifier component disposed on the plurality of lignocellulosic pieces. By “disposed on”, it is meant that the tackifier component is in contact with at least a portion of the lignocellulosic pieces. It is to be appreciated that various forms of the composite article can exist during manufacture, such as a wet/uncured state to a dry/cured state. The “wet” form of the composite article may also be referred to as a mass, furnish, or mat; whereas the “dry” form is generally the final form of the composite article, such as PB, OSB, etc. It is to be appreciated that the final form of the composite article may have some residual moisture content.

As introduced above, the tackifier component may be part of the reaction product of the adhesive system or may just be in the presence of the reaction product. Depending on the chemistry of the binder component and the tackifier component, the tackifier component may be reactive or inert with respect to the binder component. If bonding does occur between the tackifier and other components of the composite article, it may be physical, chemical, etc. It is also believed that certain tackifier components may impart a degree of hydrogen bonding to the composite article. The tackifier component is useful for imparting tack to the composite article while in production, e.g. while in a mat form. It is believed that if only used alone, the binder component, in certain instances, imparts insufficient tack to the wet composite article (e.g. mat or furnish), such that the mat of the composite article can be undesirably distorted prior to completion of forming the composite article. Said another way, it is believed that the tackifier component serves as an adhesive during production of the composite article and the reaction product of the binder component serves as an adhesive after production of the composite article. In this way, both the binder and tackifier components are part of the adhesive system of the present invention.

The tackifier component may be comprised of various materials to impart tack to the composite article, and may include one or more different types of tackifiers. Without being bound or limited by any particular theory, it is believed that the degree of tack that is imparted to the composite article typically varies from tackifier to tackifier. Different levels of tack may be required based on the type of composite article being formed. For example, the lignocellulosic pieces themselves can “stick” to or orient themselves relative to each other based on size and shape, such that the level of “supplemental” tack required by employing the tackifier component can vary.

The type and/or degree of tack can vary from tackifier to tackifier. Depending on the tackifier component, tack imparted thereby can vary in its latency, such as requiring time to accrue or can rapidly decrease from the time of application. Some tackifiers can be more dependent on the presence of water for tack. While other tackifiers, less so, and have more of a “green tack” character. Some tackifiers are pressure dependent, devoid of some of the traditional visual tell-tale signs of tack as loose furnish, e.g., “slumping”, “snowballing”, “lava-flowing”, “wet-look”, etc., as understood in the art.

Preferably, the type and amount of tackifier component employed should be that which, in combination with the binder component to form/define the adhesive system, emulates or improves the tack profile (i.e., latency, rigidity and elasticity) of a conventional UF resin that satisfies a particular requirement for a composite article, e.g. a manufacturer of composite articles may have certain criteria that must be met. As such, if such a manufacturer utilizes UF or PF resins, then a combination of the binder component and the tackifier component can be tailored to obtain the criteria desired.

The tackifier component can be of various types, chemistries, forms, and/or properties. It is believed that exemplary tackifiers include, but are not limited to, polymeric tackifiers; highly polar and/or ionic tackifiers; tackifiers that impart H-bonding, e.g. a high concentration of O, OH, NH and N functionality; water-based tackifiers; and easily dispersible (e.g. low viscosity) tackifiers. It is believed that certain tackifiers, such as those with cationic charges, are useful for imparting tack to the composite article. It is also believed that tackifiers with lower Tg, or those that impart lower Tg, can be useful for imparting desirable properties to the composite articles. It is also believed that certain tackifiers impart plasticization and/or film formation, and tackiness, which may increase with pressure. It is also believed that certain tackifiers act as pressure-sensitive adhesives thereby imparting tack. In certain embodiments, the tackifier component comprises a continuous phase and a discontinuous phase.

In a first embodiment of the tackifier component, the tackifier component comprises a homo- and/or co-polymer of vinyl acetate (hereinafter referred to as the polymer). The polymer can be of any type of a homo- and/or co-polymer of vinyl acetate understood in the art. The polymer can be formed from various monomers understood in the art, such as the monomers described below. In one embodiment, the polymer is polyvinyl acetate. In another embodiment, the polymer is an ethylene-vinyl acetate (EVA) copolymer. In another embodiment, the polymer is a vinyl-acetate ethylene (VAE) copolymer. It is to be appreciated that the tackifier component can comprise a combination of different polymers.

In certain embodiments, the polymer comprises or comprises the reaction product of: i) a vinyl ester of a C₂ to C₁₃ alkyl carboxylic acid ester, ii) ethylene, iii) a C₁ to C₂₀ alkyl (meth)acrylate, iv) an ethylenically unsaturated carboxylic acid, or v) combinations thereof.

In one embodiment, the polymer comprises, or comprises the reaction product of, the i) vinyl ester of a C₂ to C₁₃ alkyl carboxylic acid ester. The i) vinyl ester of a C₂ to C₁₃ alkyl carboxylic acid ester can be selected from the group of a vinyl acetate or other vinyl ester of carboxylic acid with a linear or branched C₁ to C₁₂ alkyl chain.

In another embodiment, the polymer comprises, or comprises the reaction product of, the iii) C₁ to C₂₀ alkyl (meth)acrylate. The iii) C₁ to C₂₀ alkyl (meth)acrylate can be selected from the group of methyl (meth)acrylate, ethyl (meth)acrylate, propyl (meth)acrylate, n-butyl (meth)acrylate, isobutyl (meth)acrylate, t-butyl (meth)acrylate, pentyl (meth)acrylate, hexyl (meth)acrylate, cyclohexyl (meth)acrylate, benzyl (meth)acrylate, 2-ethylhexyl (meth)acrylate, heptyl (meth)acrylate, n-octyl (meth)acrylate, nonyl (meth)acrylate, decyl (meth)acrylate, undecyl (meth)acrylate, dodecyl (meth)acrylate, tridecyl (meth)acrylate, lauryl (meth)acrylate, stearyl (meth)acrylate, isobornyl (meth)acrylate, norbornyl (meth)acrylate, 4-tertbutylcyclohexyl (meth)acrylate, 3,3,5-trimethylcyclohexyl (meth)acrylate, dimethyl maleate, n-butyl maleate, propylene glycol (meth)acrylate, carbodiimide (meth)acrylate, t-butylaminoethyl (meth)acrylate, 2-t-butylaminoethyl (meth)acrylate, N,N-dimethylaminoethyl (meth)acrylate, and combinations thereof.

In another embodiment, the polymer comprises, or comprises the reaction product of, the iv) ethylenically unsaturated carboxylic acid. The iv) ethylenically unsaturated carboxylic acid can be selected from the group of (meth)acrylic acid, maleic acid, fumaric acid, itaconic acid, ethacrylic acid, crotonic acid, citraconic acid, cinnamic acid, and combinations thereof.

In certain embodiments, the polymer has a glass transition temperature (Tg) of from about −85° C. to about +25° C., alternatively from about −60° C. to about 0° C., alternatively from about −55° C. to about −20° C., alternatively from about −55° C. to about −35° C., alternatively from about −50° C. to about −15° C.

In certain embodiments, the polymer has a weight average molecular weight (Mw) of from about 2,000 to about 3,000,000, alternatively from about 20,000 to about 1,500,000, alternatively from about 200,000 to about 650,000. In certain embodiments, the polymer has a number average molecular weight (Mn) of from about 1,000 to about 2,000,000, alternatively from about 10,000 to about 1,000,000, alternatively from about 55,000 to about 100,000.

As introduced above, the tackifier component may be reactive with the binder component. As such, in certain embodiments, the polymer has at least one functional group reactive with the binder component. The polymer can include various types of functional groups, including, but not limited to, a carboxyl functional group, a hydroxyl functional group, or a combination thereof. Those of skill in the art appreciate that various groups can be imparted, depending on the components and amounts thereof used to form the polymer.

The tackifier component can be in various forms, such as in a dispersion form, an emulsion form, or a resin form (e.g. a solvent-free form), e.g. raw EVA copolymer. In certain embodiments, the tackifier component is a dispersion comprising the polymer and water, a solution comprising the polymer and a solvent different than water, or is free of water/solvent. Adjusting the form of the tackifier component can be useful for application purposes. In certain embodiments, the tackifier component includes from about 1 to about 80 parts per weight solids, e.g. acyclic polymer, based on 100 parts by weight of the tackifier component.

Specific examples of suitable polymer dispersions, emulsions, and/or resins are commercially available from a variety of commercial suppliers, including the family of products designated under the trademark ELVAX®, which are commercially available from E.I. DuPont de Nemours of Wilmington, Del.; the family of products designated under the trademark HONEYWELL A-C®, such as HONEYWELL A-C® 430, which are commercially available from Honeywell of Morristown, N.J.; the family of products designated under the trademark X-LINK®, such as X-LINK® 2873, and under the trademark DUR-O-SET®, such are DUR-O-SET® E310 and E351, which are commercially available from Celanese Corporation of Dallas, Tex.

In certain embodiments, the tackifier component comprises a tackifier different than the polymers described and exemplified above. Other specific types of tackifiers include, but are not limited to, rosin based products; polysaccharides; polyol-containing acrylates; polypeptides; and cellulosic gums. Additional specific examples of suitable tackifiers include, but are not limited to, the family of products designated under the trademark SOKALAN®, such as SOKALAN® CP7, SOKALAN® CP10S, SOKALAN® PA80S, SOKALAN® CP 12S, SOKALAN® 165, SOKALAN® HP53 and SOKALAN® HP56K; the family of products designated under the trademark ACRODUR®, such as ACRODUR® 950L; polyetheramines, including the family of products designated under the trademark JEFFAMINE®, such as JEFFAMINE® EDR-148, JEFFAMINE® T-403, JEFFAMINE® T-5000; polysaccharides; and sodium carboxymethylcellulose (CMC) MF, CMC M1F and CMC LF.

It is to be appreciated that other tackifiers that may be used include other grades of the trademarked products exemplified above. Many of the aforementioned tackifiers are commercially available from BASF Corporation. The technical data sheets and material safety data sheets of the same are incorporated herein by reference in their entirety. It is to be appreciated that the tackifier component may include a combination of two or more of the tackifiers described and exemplified above.

Typically, such as in OSB, PB, scrimber, or MDF applications, the tackifier component is utilized in an amount of from about 0.1 to about 10, alternatively from about 1 to about 10, alternatively from about 1 to about 7.5, alternatively from about 1 to about 5, parts by weight, each based on 100 parts by weight of the lignocellulosic pieces.

Typically, the binder component and tackifier component are utilized in the composite article in a combined amount of from about 1 to about 25, alternatively from about 1 to about 15, alternatively from about 1 to about 10, alternatively from about 5 to about 10, parts by weight, each based on 100 parts by weight of the lignocellulosic pieces. By “combined amount”, it is meant that each of the binder component and the tackifier component are individually utilized in the composite article in a positive amount, i.e., in an amount greater than zero parts by weight based 100 parts by weight of the lignocellulosic pieces. The binder component and tackifier component can be utilized in the composite article in various weight ratios. It is to be appreciated that the other optional components, e.g. the additive component, can also be utilized to form the composite article.

The binder component and the tackifier component may be supplied to consumers for use by various means, such as in railcars, tankers, large sized drums and containers or smaller sized drums, totes, and kits. For example, one drum can contain the binder component and another drum can contain the tackifier component. In general, providing the components to consumers separately reduces premature potential reaction of the components and provides for increased formulation flexibility for forming the adhesive. For example, a consumer can select a specific binder component and specific tackifier component, and amounts thereof, to prepare the composite article formed therefrom. If other components are employed, such as the additive component, e.g. the catalyst component, such components can be provided separately or premixed with one of or more of the binder component or the tackifier component.

In certain embodiments, the composite article further comprises polymeric particles. In these embodiments, the polymeric particles are generally co-mingled with the lignocellulosic pieces. The polymeric particles can be useful for reducing weight of the composite article. In these embodiments, the adhesive system is generally disposed on the lignocellulosic pieces and the polymeric particles for bonding the lignocellulosic pieces and the polymeric particles.

If employed, the polymeric particles can be of various sizes, distributions, shapes, and forms. Typically, the polymeric particles are in the form of beads. In certain embodiments, the polymeric particles are expanded polystyrene beads; however, the polymeric particles can be formed from various thermoplastics and/or thermosets understood in the art. Specific examples of suitable polymeric particles are commercially available from BASF Corporation under the trademark of STYROPOR®. Other examples of suitable polymeric particles, for purposes of the present invention, are described in U.S. Publication No. 2011/0003136 to Schmidt et al., the disclosure of which is incorporated herein by reference in its entirety to the extent it does not conflict with the general scope of the present invention.

If employed, the polymeric particles can be utilized in an amount of from about 1 to about 30, alternatively from about 1 to about 20, alternatively from about 1 to about 10, parts by weight, each based on 100 parts by weight of the lignocellulosic pieces.

The composite article may be of various sizes, shapes, and thickness. For example, the composite article can be configured to mimic conventional composite articles, such as OSB, PB, scrimber, and MDF beams, boards, or panels. The composite article can also be of various complex shapes, such as moldings, fascias, furniture, etc. As described above, in certain embodiments, the composite article is fiberboard, e.g. MDF. In other embodiments, the composite article is OSB, scrimber, or OSL. In yet other embodiments, the composite article is PB. The composite article can comprise one or more layers. For example, if the composite article is OSB, the composite article can comprise one layer, e.g. a core layer, two layers, e.g. a core layer and a face/fascia layer, or three or more layers, e.g. a core layer and two fascia layers, as understood by those skilled in the art.

In certain embodiments, such as for OSB applications, the composite article has a first fascia layer comprising a first portion of the plurality of lignocellulosic pieces compressed together and substantially oriented in a first direction. The composite article further has a second fascia layer spaced from and parallel to the first fascia layer and comprising a second portion of the plurality of lignocellulosic pieces compressed together and substantially oriented in the first direction. The composite article yet further has a core layer disposed between the first and second fascia layers and comprising a remaining portion of the plurality of lignocellulosic pieces compressed together and substantially oriented in a second direction different than the first direction. In these embodiments, at least one of the portions of the plurality of lignocellulosic pieces is compressed together with the adhesive of present invention. The fascia layers can also include the adhesive in addition to, or alternate to, the core layer. In certain embodiments, the core layer comprises the polymeric particles along with the lignocellulosic pieces, as described above. The layers can each comprises different adhesives, depending on the specific components employed in the respective adhesives of the layers. In certain embodiments, at least one of the layers, e.g. one or both of the fascia layers, can comprise PF resin, as understood in the art. Each of the layers can be of various thicknesses, such as those encountered with conventional OSB layers. Those skilled in the art appreciate that OSL typically has lignocellulosic pieces substantially orientated in only one direction. Other types of composite articles, e.g. wood composites, and their methods of manufacture, that can be formed for purposes of the present invention, e.g. by employing the adhesive of the present invention, are described by pages 395 through 408 of THE POLYURETHANES HANDBOOK (David Randall & Steve Lee eds., John Wiley & Sons, Ltd. 2002), which is incorporated herein by reference in their entirety.

The composite article has an original thickness, i.e., a thickness after manufacture, e.g. after pressing the mat to form the final, i.e., cured, composite article. Typically, due to the adhesive of the present invention, the composite article exhibits a swelling of less than about 10%, alternatively less than about 5%, alternatively less than about 3%, based on a 24-hour cold-soak test according to ASTM D1037. The thickness can vary, but is typically of from about 0.25 to about 10, alternatively from about 0.25 to about 5, alternatively from about 0.25 to about 1.5, inches. It is to be appreciated that describing thicknesses may not be suitable when describing complex shapes other than boards or panels. As such, the composite article can be of various dimensions based on final configuration of the composite article.

The composite article has an internal bond (IB) strength. Typically, the IB strength is greater than about 20, alternatively greater than about 30, alternatively greater than about 40, pounds per square inch (psi), according to ASTM D1037. In certain embodiments, the composite article typically has an IB strength of from about 50 to about 500, alternatively from about 100 to about 300, alternatively from about 150 to about 250, psi, according to ASTM D1037.

As understood to those of ordinary skill in the art, IB strength is a “brittle strength” property. Typically, in conventional composite articles, as IB strength increases, flexural properties such as modulus of elasticity (MOE) and modulus of rupture (MOR) change, specifically, MOE generally decreases as IB strength increases. However, quite surprisingly, with the composite article of the present invention, MOE generally increases as IB strength increases.

Typically, the composite article has a MOE greater than 75,000, alternatively greater than 95,000, alternatively greater than 100,000, alternatively greater than 110,000, psi, according to ASTM D1037. Typically, the composite article has a MOR greater than 3,000, alternatively greater than 3,250, alternatively greater than 3,300, alternatively greater than 3,500, psi, according to ASTM D1037.

The present invention also provides a method of forming the composite article. To form the composite article, the lignocellulosic pieces are generally provided. As described and exemplified above, the lignocellulosic pieces can be derived from a variety of lignocellulosic sources, and can be formed from a variety of processes, as understood in the art.

The binder component and the tackifier component, and typically other components, e.g. the additive component, (all of which are hereinafter referred to simply as the components) are applied to the plurality of lignocellulosic pieces to form a mass. The components can be applied to the lignocellulosic pieces at the same time, or can be applied to the lignocellulosic pieces at different times. In one embodiment, the binder component is applied the lignocellulosic pieces prior to the tackifier component. In another embodiment, the binder component is applied to the lignocellulosic pieces after the tackifier component. In yet another embodiment, the binder component and the tackifier component are applied simultaneously to the lignocellulosic pieces. For example, the binder component can be applied to the lignocellulosic pieces, and then the tackifier component can be applied to the lignocellulosic pieces at some time later, or vice versa. Alternatively, the components can be applied at the same time, either separately, and/or premixed. In one embodiment, the components are blended to form the adhesive system, such that the adhesive system is applied to the lignocellulosic pieces. The components can be applied to the lignocellulosic pieces by various methods, such as by mixing, tumbling, rolling, spraying, sheeting, blow-line resination, blending (e.g. blow-line blending), etc. For example, the components and the lignocellulosic pieces can be mixed or milled together during the formation of the mass, also referred to as a binder-lignocellulosic mixture or “furnish”, as further described below.

Typically, the components are applied to the lignocellulosic pieces by a spraying, an atomizing or a fogging process, as understood in the art. The plurality of lignocellulosic pieces having the binder component and the tackifier component applied thereon are then disposed on a carrier, and generally form (or define) the mass. The mass can then be formed into mat, such as by dropping the mass onto a carrier, e.g. a conveyor belt, or, alternatively, the mat can be formed directly on the carrier, i.e., the binder-lignocellulosic mixture is formed directly on the carrier. In other words, the plurality of lignocellulosic pieces having the binder component and the tackifier component applied thereon can be arranged on the carrier to form the mass in various ways. The mass can then be fed to a former, which generally forms the mass into a mat having a predetermined width and a predetermined thickness with the plurality of lignocellulosic pieces loosely oriented on the carrier. The predetermined width and thickness of the mat are determined according to final widths and thicknesses desired for the composite article, as described further below.

As described above, the mat can then be formed in various shapes, such as boards or panels, or formed into more complex shapes, as described and exemplified above, such as by molding or extruding the mat to form the composite article.

In certain embodiments, the components are sprayed, atomized, and/or fogged onto the lignocellulosic pieces while the lignocellulosic pieces are being agitated in suitable equipment. Spraying, atomizing and fogging can occur via use of nozzles, such as one nozzle for each individual component supplied thereto, or nozzles that have two or more components premixed and supplied thereto. Generally, at least one nozzle applies the binder component and at least one nozzle applies the tackifier component. To maximize coverage of the lignocellulosic pieces, the components are generally applied by spraying droplets or atomizing or fogging particles of the components onto the lignocellulosic pieces as the lignocellulosic pieces are being tumbled in a rotary blender or similar apparatus. As another example, the lignocellulosic pieces can be coated with the components in a rotary drum blender equipped with at least one, typically at least two or three spinning disk atomizers. Tumblers, drums, or rollers including baffles can also be used, as understood in the art. It is believed that applying shear to the components is important, especially if such components have high viscosities. Shear force can be useful for obtaining proper distribution of the components with respect to the lignocellulosic pieces, and can be obtained by specific nozzle design to obtain proper atomization of the components. It is believed that the components should be mixed very well, be it before or after application to the lignocellulosic pieces. For example, it is believed that certain polyols can be “pushed” into voids of certain tackifiers, if the isocyanate component is employed. Of course complete coverage of the lignocellulosic pieces with the components is desirable to ensure proper bonding. Atomization is useful for maximizing distribution of the components onto the lignocellulosic pieces, based in part on droplet size distribution of the components. Typically, the components are not premixed prior to application, to prevent premature reaction. As such, the components are each individually applied onto the lignocellulosic pieces via one or more nozzles, typically, by one nozzle per component to prevent premature reaction and/or contamination.

As introduced above, alternatively, the lignocellulosic pieces can be provided directly to the carrier, and the components can be applied to the lignocellulosic pieces, e.g. by spraying or sheeting, to form the mass. For example, the lignocellulosic pieces can be disposed on a conveyor belt or a plate, and then sprayed with the components to form the mass. Further, at least one of the components, e.g. the binder component, can already be present on the lignocellulosic pieces, such that the remaining component(s) of the adhesive system, e.g. the tackifier component, can then be applied to the lignocellulosic pieces and to the binder component to form the mass.

The amount of the components to be applied and mixed with the lignocellulosic pieces is dependant upon several variables including, the specific components employed, the size, moisture content and type of lignocellulosic pieces used, the intended use of the composite article, and the desired properties of the composite article. The resulting mass is typically formed into a single or multi-layered mat that is compressed into, for example, OSB, PB, scrimber, MDF, or another composite article of the desired shape and dimensions. As described above, the mass can also be formed into more complex shapes, such as by molding or extruding the mass.

The mat can be formed in any suitable manner. For example, the mass can be deposited on a plate-like carriage carried on an endless belt or conveyor from one or more hoppers spaced above the belt. When a multi-layer mat is formed, a plurality of hoppers are used with each having a dispensing or forming head extending across the width of the carriage for successively depositing a separate layer of the mass/furnish as the carriage is moved between the forming heads. The mat thickness will vary depending upon such factors as the size and shape of the lignocellulosic pieces, the particular technique used in forming the mat, the desired thickness and density of the final composite article and the pressure used during the press cycle. The thickness of the mat is usually about 5 times to about 20 times a final thickness of the composite article. For example, for flakeboard or particleboard panels of 0.5 inch thickness and a final density of about 35 lbs/ft³, the mat usually will originally be about 3 inches to about 6 inches thick. The width of the mat is usually substantially the same as a final width of the composite article; however, depending on configuration of the composite article, the final width may be a fraction of the thickness, similar to description of the thickness.

As alluded to above, the lignocellulosic pieces are loosely oriented in the mass and mat. As described above, a carrier is provided, such as a conveyor belt or plate, and the mass and eventual mat is disposed on the carrier. As also described above, the mass can either be formed directly on the carrier, and/or transferred to the carrier, after forming, e.g. in a tumbler. The tackifier component, and optionally, the binder component, substantially maintains orientation of the plurality of lignocellulosic pieces in the mass while on the carrier. For the tackifier component to maintain orientation of the lignocellulosic pieces there is no requirement that the orientation is maintained perfectly. For example, minor distortion may occur. In general, the tackifier component serves as a “tacktifier” or as “sticky” glue, and can be used as a substitute or supplemental tackifier for UF resins and/or PF resins, as well as for other adhesives. As such, the adhesive system of the present invention has tack or cold-tack. As understood by those of ordinary skill in the art, cold-tack can be determined in a variety of ways. For example, one can use a “slump” test, which employs a funnel packed full of the mass, the funnel is then tipped onto a surface and removed, such that the mass (in the shape of the funnel) remains on the surface. The funnel shaped mass can then be observed for changes in shape over time, such as changes in angle due to slumping/collapsing of the funnel shaped mass. Another example is referred to in the art as a “snowball” test, where one can grab a handful of the mass, make a ball of the mass in hand, and toss the ball up and down to determine if the ball falls apart. Other suitable tests, for purposes of the present invention, are described in ASTM D1037. Typically, for PB applications, tack tests described in the Example section below, i.e., a “Push Tack Test” and “IFD Tack Test”, are employed to determine tack imparted to the composite articles of the present invention by the tackifier component.

When the mass is formed into the mat, the tackifier component also substantially maintains the width and the thickness of the mat while the matt is on the carrier. As can be appreciated, when the carrier moves, such as by conveying, the tackifier component keeps the mat from falling apart due to vibrations. Vibrations can also occur, for example, if the carrier is a plate, and the plate is being moved to a press. Such vibrations can cause orientation problems with the lignocellulosic pieces, can cause reduced internal bond (IB) strength, and can cause other similar issues.

The composite article is typically formed from the mat by compressing the mat formed from the mass at an elevated temperature and under pressure. Typically, at least pressure is applied to the mat for an amount of time sufficient to form the composite article. Heat is also typically applied. Such conditions facilitate reaction of the adhesive system, specially, at least reaction of the binder component, to form the reaction product. By imparting tack, the tackifier component can reduce movement of the lignocellulosic pieces in the mat, such as by reducing a chance that the lignocellulosic pieces will blow apart when applying pressure to the mat. Specifically, speed of applying pressure to the mat to form the composite article can be increased relative to conventional pressing speed and/or pressures employed to form conventional composite articles, which provides economic benefits, such as increased throughput, for manufacturers of the composite article of the present invention. The same tack imparted by the tackifier component is useful during movement of the mat, such as when being conveyed.

Typically, heat is applied to the mat to facilitate cure of the adhesive system. Press temperatures, pressures and times vary widely depending upon the shape, thickness and the desired density of the composite article, the size and type of lignocellulosic pieces, e.g. wood flakes or sawdust, the moisture content of the lignocellulosic pieces, and the specific components employed. The press temperature, for example, can range from about 100° C. to about 300° C. To minimize generation of internal steam and the reduction of the moisture content of the final composite article below a desired level, the press temperature is typically less than about 250° C. and most typically from about 180° C. to about 240° C. The pressure employed is generally from about 300 to about 800 pounds per square inch (psi). Typically, the press time is from 120 to 900 seconds. The press time employed should be of sufficient duration to at least substantially cure the adhesive (in order to substantially form the reaction product) and to provide a composite article of the desired shape, dimension and strength. For the manufacture of, e.g. flakeboard or PB panels, the press time depends primarily upon the panel thickness of the composite article produced. For example, the press time is generally from about 200 seconds to about 300 seconds for a composite article with about a 0.5 inch thickness.

Other suitable methods, for forming the composite article of the present invention, are described in the U.S. Pat. Nos. 6,451,101 to Mente et al.; 6,458,238 to Mente et al.; 6,464,820 to Mente et al.; 6,638,459 to Mente et al.; 6,649,098 to Mente et al., and U.S. Pat. No. 6,344,165 to Coleman; and U.S. Publication Nos. 2003/0047278 to Mente et al.; 2005/0221078 to Lu et al.; and 2005/0242459 to Savino et al., which were introduced above.

The following examples, illustrating the composite articles of the present invention, are intended to illustrate and not to limit the invention.

### EXAMPLES

Examples of composite articles are prepared. The composite articles can be used to form articles such as particleboards. The examples are made using typical production methods for manufacturing particleboard (PB) furnishes, such that methods of manufacture do not impart differences between the examples.

In the tables below, “% Solids” refers to the total amount of polymer solids imparted by the tackifier (“Tack.”) component or binder component. It is to be appreciated that inventive examples have a combination of the tackifier and binder components, but the solids imparted by the binder is not accounted for in the tables, but rather, in the subsequent description of the tables. In contrast, with the comparative examples, the solids imparted by the binder component alone is shown in the tables.

To test tackiness of the furnishes, a “Push-Off” or “Push Tester” is employed. In this test, the furnish is formed into a 4 inch by 12 inch mat of a certain thickness. The mat is then arranged such that the mat can be pushed off of a table at a steady rate to measure a distance (in cm) at which the mat falls or breaks, due to gravity. Theoretically, the longer the mat extends, unsupported by the table, without breaking, the higher the tack therein imparted by the binder component and/or the tackifier component. A “----” symbol generally indicates that the measurement was not taken or recorded.

TABLE 1

| Example | 1 | 2 | 3 | 4 | 5 |
|---|---|---|---|---|---|
| % Solids | 1-3% | 1-3% | 1-3% | 3% | 8.8% |
| | Tack. 1 | Tack. 2 | Tack. 3 | MDI | UF |
| Mat Mass (g) | 150-165 | 150-165 | 150-165 | 151.3 | 164.5 |
| Set time (min) | 10-15 | 10-15 | 10-15 | 15 | 14 |
| Time as formed mat (min) | 1-5 | 1-5 | 1-5 | 2 | 2 |
| Elapsed time | 15-20 | 15-20 | 15-20 | 17 | 16 |
| since application (min) | | | | | |
| Ave. Distance (cm) | >>1.7 | >>1.7 | >>1.7 | 1.7 | 4.2 |
| Std. Dev. (cm) | — | — | — | 0.1 | 0.3 |

Tack. 1 comprises polyvinyl acetate.
Tack. 2 comprises an ethylene-vinyl acetate (EVA) copolymer.
Tack. 3 comprises a vinyl-acetate ethylene (VAE) copolymer.
MDI is a polymeric MDI (pMDI) with a functionality of about 2.7, and NCO content of about 31.5 wt. %, and a viscosity of about 200 cps at 25° C. The pMDI is commercially available from BASF Corporation.
UF is a conventional UF resin. The UF resin is commercially available from Hexion.

Table 1 above illustrates five examples of furnish employing different adhesive systems. Each furnish is formed by spraying and blending the components in a blender. The furnishes are made at ambient temperature. Examples 1-3 are inventive examples employing 3 wt. % of the isocyanate component, specifically, pMDI, and 1 to 3 wt. % of the respective tackifier component, balance % dry wood solids. Example 4 is a comparative example employing 3 wt. % of pMDI, balance % dry wood solids. Example 3 is a comparative example employing 8.8 wt. % of UF resin, balance % dry wood solids. Table 1 above illustrates that the average distance the mat is pushed is larger for all of the inventive examples relative to using the MDI alone (i.e., Example 4). In generally, it is believed that the distance is increased as the amount of tackifier component is increased from 1 to 3 wt. %.

As can be appreciated in the examples above, the present invention provides additional tack to cellulosic particulates resinated with conventional adhesives (i.e., binder components) in order to maintain the integrity of a pre-pressed mat during the manufacturing of wood composite panels such as PB. Based on the surprising tack results illustrated above, it is believed that the combination of the binder component and the tackifier component will increase the stability of the mat during full scale wood composite panel manufacturing.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The invention may be practiced otherwise than as specifically described within the scope of the appended claims.

1. A composite article comprising:
a plurality of lignocellulosic pieces; and
an adhesive system disposed on said plurality of lignocellulosic pieces for bonding said plurality of lignocellulosic pieces;
wherein said adhesive system comprises
a binder component, and
a tackifier component comprising a homo- and/or co-polymer of vinyl acetate for maintaining orientation of said plurality of lignocellulosic pieces during manufacture of said composite article.

2. A composite article as set forth in claim 1 wherein said polymer is polyvinyl acetate.

3. A composite article as set forth in claim 1 wherein said polymer is an ethylene-vinyl acetate (EVA) copolymer.

4. A composite article as set forth in claim 1 wherein said polymer is a vinyl-acetate ethylene (VAE) copolymer.

5. A composite article as set forth in claim 1 wherein said adhesive system is formed from said binder and said tackifier components.

6. A composite article as set forth in claim 1 wherein said polymer comprises;
i) a vinyl ester of a C₂ to C₁₃ alkyl carboxylic acid ester,
ii) ethylene,
iii) a C₁ to C₂₀ alkyl (meth)acrylate,
iv) an ethylenically unsaturated carboxylic acid, or
v) combinations thereof.

7. A composite article as set forth in claim 6 wherein said polymer comprises said i) vinyl ester of a C₂ to C₁₃ alkyl carboxylic acid ester which is selected from the group of a vinyl acetate or other vinyl ester of carboxylic acid with a linear or branched C₁ to C₁₂ alkyl chain.

8. A composite article as set forth in claim 6 wherein said polymer comprises said iii) C₁ to C₂₀ alkyl (meth)acrylate which is selected from the group of methyl (meth)acrylate, ethyl (meth)acrylate, propyl (meth)acrylate, n-butyl (meth)acrylate, isobutyl (meth)acrylate, t-butyl (meth)acrylate, pentyl (meth)acrylate, hexyl (meth)acrylate, cyclohexyl (meth)acrylate, benzyl (meth)acrylate, 2-ethylhexyl (meth)acrylate, heptyl (meth)acrylate, n-octyl (meth)acrylate, nonyl (meth)acrylate, decyl (meth)acrylate, undecyl (meth)acrylate, dodecyl (meth)acrylate, tridecyl (meth)acrylate, lauryl (meth)acrylate, stearyl (meth)acrylate, isobornyl (meth)acrylate, norbornyl (meth)acrylate, 4-tertbutylcyclohexyl (meth)acrylate, 3,3,5-trimethylcyclohexyl (meth)acrylate, dimethyl maleate, n-butyl maleate, propylene glycol (meth)acrylate, carbodiimide (meth)acrylate, t-butylaminoethyl (meth)acrylate, 2-t-butylaminoethyl (meth)acrylate, N,N-dimethylaminoethyl (meth)acrylate, and combinations thereof.

9. A composite article as set forth in claim 6 wherein said polymer comprises said iv) ethylenically unsaturated carboxylic acid which is selected from the group of (meth)acrylic acid, maleic acid, fumaric acid, itaconic acid, ethacrylic acid, crotonic acid, citraconic acid, cinnamic acid, and combinations thereof.

10. (canceled)

11. A composite article as set forth in claim 1 wherein said polymer has:
a) a weight average molecular weight (Mw) of from about 2,000 to about 3,000,000;
b) a number average molecular weight (Mn) of from about 1,000 to about 2,000,000; and/or
c) a glass transition temperature (Tg) of from about −85° C. to about +25° C.

12. (canceled)

13. A composite article as set forth in claim 1 wherein said binder component comprises an isocyanate component, a formaldehyde resin, a protein-based adhesive, or a combination thereof.

14. A composite article as set forth in claim 13 wherein said binder component comprises said isocyanate component, and wherein said isocyanate component is selected from the group of diphenylmethane diisocyanates (MDIs), polymeric diphenylmethane diisocyanates (PMDIs), and combinations thereof.

15. (canceled)

16. A composite article as set forth in claim 13 wherein said binder component comprises said formaldehyde resin, and wherein said formaldehyde resin is selected from the group of phenol formaldehyde (PF) resins, urea formaldehyde (UF), melamine UF, and combinations thereof.

17. (canceled)

18. A composite article as set forth in claim 1 wherein:
a) said binder component is utilized in an amount of from about 1 to about 20 parts by weight based on 100 parts by weight of said plurality of lignocellulosic pieces; and/or
b) said tackifier component is utilized in an amount of from about 1 to about 10 parts by weight based on 100 parts by weight of said plurality of lignocellulosic pieces.

19. (canceled)

20. A composite article as set forth in claim 1 wherein said composite article is particleboard.

21. A method of forming a composite article, said method comprising the steps of:
applying a binder component to a plurality of lignocellulosic pieces;
applying a tackifier component comprising a homo- and/or co-polymer of vinyl acetate to the plurality of lignocellulosic pieces;
disposing the plurality of lignocellulosic pieces having the binder component and the tackifier component applied thereon on a carrier to form a mass; and
applying pressure to the mass for an amount of time sufficient to form the composite article;
wherein the tackifier component maintains orientation of the plurality of lignocellulosic pieces in the mass while on the carrier.

22. A method as set forth in claim 21 wherein the tackifier component is applied to the plurality of lignocellulosic pieces prior to applying the binder component to the plurality of lignocellulosic pieces.

23. A method as set forth in claim 21 wherein the binder component is applied to the plurality of lignocellulosic pieces prior to applying the tackifier component to the plurality of lignocellulosic pieces.

24. A method as set forth in claim 21 further comprising the step of blending the binder component and the tackifier component to form an adhesive system prior to applying the binder component and the tackifier component to the plurality of lignocellulosic pieces such that the adhesive system is applied to the plurality of lignocellulosic pieces.

25. A method as set forth in claim 21 wherein the binder component and the tackifier component are applied simultaneously to the plurality of lignocellulosic pieces.

26. A method as set forth in claim 21 further comprising the step of applying heat to the mass for an amount of time sufficient to form the composite article.

27-44. (canceled)
